(19) United States
(12) Patent Application Publication
(10) Pub. No.: US 2018/0188469 A1
(43) Pub. Date: Jul. 5, 2018

(54) LENS MODULE AND ASSEMBLING METHOD OF LENS MODULE

(71) Applicant: Lite-On Technology Corporation, Taipei (TW)

(72) Inventors: Chi-Chu Hsiao, Taipei (TW); Shih-Chieh Yen, Taipei (TW); Chun-Ta Li, Taipei (TW)

(73) Assignee: Lite-On Technology Corporation, Taipei (TW)

(21) Appl. No.: 15/822,210

(22) Filed: Nov. 27, 2017

Related U.S. Application Data
(60) Provisional application No. 62/441,570, filed on Jan. 3, 2017.

(30) Foreign Application Priority Data
Oct. 20, 2017 (CN) 201710983459.1

(51) Int. Cl. G02B 7/02; G02B 7/00; H04N 17/00

(52) U.S. Cl. CPC G02B 7/023; G02B 7/021; G02B 13/02; H04N 17/002; G02B 7/003

(57) ABSTRACT

A lens module includes a frame, two lens assemblies, and an optical element. The frame has two first inner surfaces and two first positioning structures, and the two first positioning structures are respectively formed on the two first inner surfaces. The two lens assemblies are disposed in the frame. The optical element is disposed in the frame and is located between the two lens assemblies, wherein two side surfaces of the optical element respectively lean against the two first positioning structures.

### CROSS-REFERENCE TO RELATED APPLICATION

This application claims the priority benefits of U.S. provisional application Ser. No. 62/441,570, filed on Jan. 3, 2017 and China application serial no. 201710983459.1, filed on Oct. 20, 2017. The entirety of each of the above-mentioned patent applications is hereby incorporated by reference herein and made a part of this specification.

### BACKGROUND OF THE INVENTION

### Field of the Invention

The disclosure relates to an optical module and an assembling method of an optical module, and in particular, to a lens module and an assembling method of a lens module.

### Description of Related Art

Portable electronic devices such as smartphones and tablet computers have gradually become prevalent in the consumer market. They integrate functions including communication, photography, satellite positioning, word processing, music playing, etc. to meet consumers' demand. In terms of the photography function of smartphones, some smartphones integrate a wide-angle lens and a telephoto lens to allow a user to perform more professional photography through smartphones. However, in a lens module integrating a wide-angle lens and a telephoto lens, a size and a corresponding telephoto capability of the telephoto lens are confined by the miniaturization design trend of smartphones, and photography quality of the lens module is generally affected by poor assembly positioning precision of an optical element and lens assemblies.

### SUMMARY OF THE INVENTION

Some embodiments of the invention provide a lens module and an assembling method of a lens module to allow the lens module to exhibit excellent telephoto capability and to enhance assembly positioning precision of the lens module.

A lens module according to an embodiment of the invention includes a frame, two lens assemblies, and an optical element. The frame has two first inner surfaces and two first positioning structures, and the two first positioning structures are respectively formed on the two first inner surfaces. The two lens assemblies are disposed in the frame. The optical element is disposed in the frame and is located between the two lens assemblies, wherein two side surfaces of the optical element respectively lean against the two first positioning structures.

In an embodiment of the invention, an optical axis of one of the lens assemblies passes through the optical element, and an optical axis of the other one of the lens assemblies does not pass through the optical element.

In an embodiment of the invention, the frame includes a frame portion and a partition portion. The frame portion surrounds the two lens assemblies and the optical element. The partition portion is located in the frame portion. The optical element and one of the lens assemblies are respectively located on two opposite sides of the partition portion. The frame portion has one of the first inner surfaces. The partition portion has the other one of the first inner surfaces.

In an embodiment of the invention, the two first inner surfaces are vertical to each other.

In an embodiment of the invention, each of the first positioning structures includes two first protrusion bars, and each of the side surfaces of the optical element leans against the corresponding two first protrusion bars.

In an embodiment of the invention, the frame has two second inner surfaces and two second positioning structures. The two second positioning structures are respectively formed on the two second inner surfaces, and two side surfaces of one of the lens assemblies respectively lean against the corresponding two second positioning structures.

In an embodiment of the invention, the two second inner surfaces are vertical to each other.

In an embodiment of the invention, each of the second positioning structures includes two second protrusion bars, and each of the side surfaces of the lens assembly leans against the corresponding two second protrusion bars.

In an embodiment of the invention, an inner side of the frame includes a protrusion rib, and an outer side of the optical element has a recess, wherein the protrusion rib fits with the recess.

An assembling method of a lens module according to an embodiment of the invention includes: providing a frame having two first inner surfaces and two first positioning structures, wherein the two first positioning structures are respectively formed on the two first inner surfaces; disposing two lens assemblies in the frame; disposing an optical element in the frame, such that the optical element is located between the two lens assemblies; and leaning two side surfaces of the optical element respectively against the two first positioning structures.

In an embodiment of the invention, the step of disposing the two lens assemblies in the frame includes: configuring an optical axis of one of the lens assemblies to pass through the optical element; and configuring an optical axis of the other one of the lens assemblies not to pass through the optical element.

In an embodiment of the invention, the step of disposing the two lens assemblies and the optical element in the frame includes: arranging the two lens assemblies and the optical element along a first direction; configuring an optical axis of one of the lens assemblies to be perpendicular to the first direction; and configuring an optical axis of the other one of the lens assemblies to be parallel to the first direction.

In an embodiment of the invention, the assembling method includes: placing the frame on a positioning plane of a jig; pushing the optical element along a first direction to one of the first positioning structures; pushing the optical element along a second direction to the other one of the first positioning structures; and pushing the optical element along a third direction to the positioning plane, wherein the first direction, the second direction, and the third direction are perpendicular to each other.

In an embodiment of the invention, each of the first positioning structures includes two first protrusion bars, and the step of leaning the two side surfaces of the optical element respectively against the two first positioning structures includes: leaning each of the side surfaces of the optical element against the corresponding two first protrusion bars.

In an embodiment of the invention, the frame has two second inner surfaces and two second positioning structures, and the two second positioning structures are respectively formed on the two second inner surfaces. The assembling method includes: leaning two side surfaces of one of the lens assemblies respectively against the two second positioning structures.

In an embodiment of the invention, the assembling method includes: placing the frame on a positioning plane of a jig; pushing the lens assembly along a first direction to one of the second positioning structures; pushing the lens assembly along a second direction to the other one of the second positioning structures; and pushing each of the lens assemblies along a third direction to the positioning plane, wherein the first direction, the second direction, and the third direction are perpendicular to each other.

In an embodiment of the invention, each of the second positioning structures includes two second protrusion bars, and the step of leaning the two side surfaces of the lens assembly respectively against the corresponding two second positioning structures includes: leaning each of the side surfaces of the lens assembly against the corresponding two second protrusion bars.

In an embodiment of the invention, an inner side of the frame includes a protrusion rib, and an outer side of the optical element has a recess. The assembling method includes: fitting the protrusion rib with the recess.

In an embodiment of the invention, the assembling method includes: aligning the optical element with a calibration pattern; transmitting an image light beam of the calibration pattern to one of the lens assemblies through the optical element to allow the lens assembly to capture a calibration image corresponding to the calibration pattern; and adjusting a tilted angle of the lens assembly relative to the frame according to the calibration image.

In an embodiment of the invention, the assembling method includes: aligning one of the lens assemblies with a calibration pattern; capturing a calibration image corresponding to the calibration pattern through the lens assembly; and adjusting a tilted angle of the lens assembly relative to the frame according to the calibration image.

Based on the above, in the embodiments of the invention, the optical element is disposed between the two lens assemblies. The optical element is, for example, a prism, a reflecting mirror, or another element that changes a transmission direction of a light beam, such that an image light beam from outside is changed in its transmission direction and then is transmitted to the telephoto lens assembly, and thereby there is greater design freedom for a configuration direction of the telephoto lens assembly in the lens module. Accordingly, when the lens module of the embodiments of the invention is applied to a portable electronic device, a size and a corresponding telephoto capability of the telephoto lens assembly are not strictly confined by the miniaturization design trend of portable electronic devices. Moreover, the two first inner surfaces of the frame are respectively provided with the first positioning structures. Accordingly, the optical element is precisely positioned through the first positioning structures by adjusting a size of the first positioning structures in the manufacturing process of the frame, so that the optical element will not be poorly positioned because an overall size of the first inner surfaces of the frame cannot be precisely controlled.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a perspective view illustrating a lens module according to an embodiment of the invention.

FIG. 2 is a top view illustrating the lens module of FIG. 1.

FIG. 3 is a perspective view illustrating a frame of FIG. 1.

FIG. 4 illustrates a partial structure of the lens module of FIG. 1.

FIG. 5 is a top view illustrating a lens module according to another embodiment of the invention.

FIG. 6 is a top view illustrating a lens module according to another embodiment of the invention.

FIG. 7 is a top view illustrating a lens module according to another embodiment of the invention.

FIG. 8 is a flowchart illustrating an assembling method of a lens module according to an embodiment of the invention.

FIG. 9 illustrates a positioning method of an optical element of FIG. 1.

FIG. 10 and FIG. 11 illustrate a positioning method of lens assemblies of FIG. 1.

### DESCRIPTION OF THE EMBODIMENTS

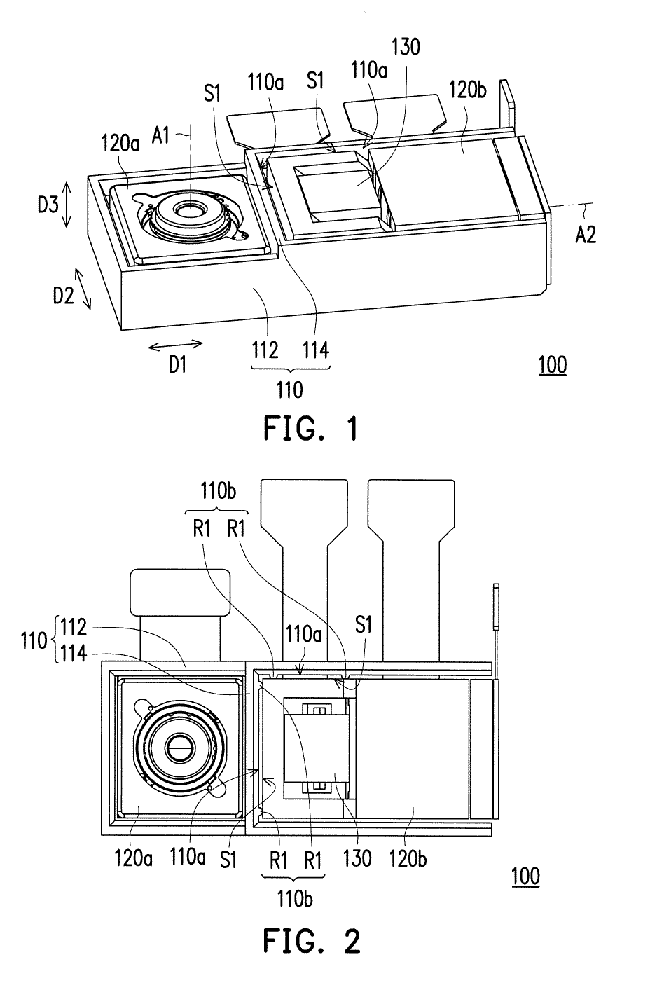

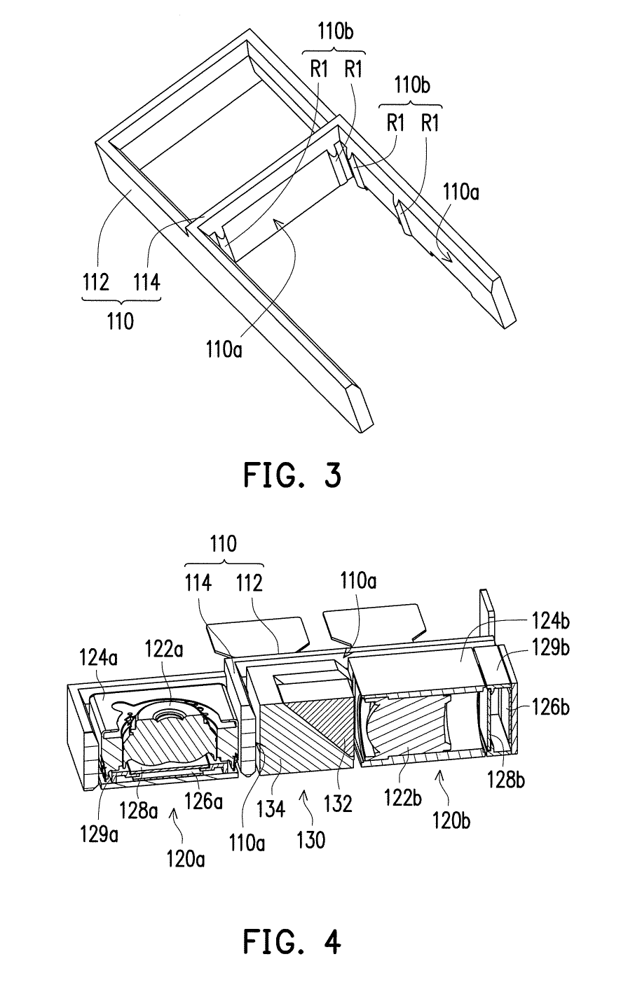

FIG. 1 is a perspective view illustrating a lens module according to an embodiment of the invention. FIG. 2 is a top view illustrating the lens module of FIG. 1. FIG. 3 is a perspective view illustrating a frame of FIG. 1. Referring to FIG. 1 to FIG. 3, a lens module 100 of the present embodiment includes a frame 110, a lens assembly 120a, a lens assembly 120b, and an optical element 130. The frame 110 is, for example, a metal frame manufactured by a die casting process. The lens assembly 120a is, for example, a wide-angle lens assembly, and the lens assembly 120b is, for example, a telephoto lens assembly. The two lens assemblies 120a, 120b are disposed in the frame 110. The optical element 130 is disposed in the frame 110 and is located between the two lens assemblies 120a, 120b.

The optical element 130 is, for example, a prism, a reflecting mirror, or another element that changes a transmission direction of a light beam, such that an image light beam from outside is changed in its transmission direction and then is transmitted to the telephoto lens assembly (the lens assembly 120b), and thereby there is greater design freedom for a configuration direction of the telephoto lens assembly (the lens assembly 120b) in the lens module 100. Accordingly, when the lens module 100 is applied to a portable electronic device, a size and a corresponding telephoto capability of the telephoto lens assembly (the lens assembly 120b) are not strictly confined by the miniaturization design trend of portable electronic devices.

Specifically, as shown in FIG. 1, the two lens assemblies 120a, 120b and the optical element 130 are arranged along a first direction D1. An optical axis A1 of the lens assembly 120a is configured to be perpendicular to the first direction D1 and not to pass through the optical element 130, and the image light beam from outside directly enters the lens assembly 120a along the optical axis A1. An optical axis A2 of the lens assembly 120b is configured to be parallel to the first direction D1 and to pass through the optical element 130, and the image light beam from outside enters the optical element 130 along a direction parallel to the optical axis A1, is changed in its transmission direction by the optical element 130, and then enters the lens assembly 120b along the optical axis A2. Through such configuration, with an extension direction of the optical axis A1 being a thickness direction of the portable electronic device, a dimension of the lens assembly 120b along its optical axis A2 is not confined by a thickness design demand of the portable electronic device, and a more desirable telephoto capability is thereby achieved.

The frame 110 of the present embodiment has two first inner surfaces 110a and two first positioning structures 110b. The two first positioning structures 110b are respectively formed on the two first inner surfaces 110a, and two side surfaces S1 of the optical element 130 respectively lean against the two first positioning structures 110b. Accordingly, the optical element 130 is precisely positioned through the first positioning structures 110b by adjusting a size of the first positioning structures 110b in the manufacturing process of the frame 110, so that the optical element 130 will not be poorly positioned because an overall size of the first inner surfaces 110a of the frame 110 cannot be precisely controlled.

The frame 110 of the present embodiment includes a frame portion 112 and a partition portion 114. The frame portion 112 surrounds the two lens assemblies 120a, 120b and the optical element 130, the partition portion 114 is located in the frame portion 112, and the optical element 130 and the lens assembly 120a are respectively located on two opposite sides of the partition portion 114. The frame portion 112 has one of the first inner surfaces 110a, the partition portion 114 has the other one of the first inner surfaces 110a, and the two first inner surfaces 110a are vertical to each other. In the present embodiment, each of the first positioning structures 110b includes two first protrusion bars R1, and each of the side surfaces S1 of the optical element 130 leans against the corresponding two first protrusion bars R1. In other embodiments, the first positioning structure 110b may be a structure in another form formed on the first inner surface 110a, and the invention is not limited hereto.

FIG. 4 illustrates a partial structure of the lens module of FIG. 1. Referring to FIG. 4, specifically, the lens assembly 120a of the present embodiment includes a wide-angle lens 122a, a voice coil motor 124a, an image sensor 126a, an optical filter 128a, and a holder 129a. The voice coil motor 124a is connected to the wide-angle lens 122a and is configured to drive the wide-angle lens 122a. The holder 129a is configured to support the voice coil motor 124a and the optical filter 128a. The image sensor 126a and the optical filter 128a are aligned with the wide-angle lens 122a, such that the image light beam from outside reaches the image sensor 126a after passing through the wide-angle lens 122a and the optical filter 128a. The optical element 130 of the present embodiment includes a prism 132 and a voice coil motor 134, and the voice coil motor 134 is connected to the prism 132 and is configured to drive the prism 132. The lens assembly 120b of the present embodiment includes a telephoto lens 122b, a voice coil motor 124b, an image sensor 126b, an optical filter 128b, and a holder 129b. The voice coil motor 124b is connected to the telephoto lens 122b and is configured to drive the telephoto lens 122b. The holder 129b is configured to support the voice coil motor 124b and the optical filter 128b. The image sensor 126b and the optical filter 128b are aligned with the telephoto lens 122b, such that the image light beam from the prism 132 reaches the image sensor 126b after passing through the telephoto lens 122b and the optical filter 128b.

FIG. 5 is a top view illustrating a lens module according to another embodiment of the invention. The embodiment shown in FIG. 5 differs from the embodiment shown in FIG. 2 in that the frame 110 has two second inner surfaces 110c and two second positioning structures 110d. The two second positioning structures 110d are respectively formed on the two second inner surfaces 110c, and two side surfaces S2 of the lens assembly 120a respectively lean against the two second positioning structures 110d. Similarly, the frame 110 has two second inner surfaces 110e and two second positioning structures 110f. The two second positioning structures 110f are respectively formed on the two second inner surfaces 110e, and two side surfaces S3 of the lens assembly 120b respectively lean against the two second positioning structures 110d. Accordingly, the lens assemblies 120a, 120b are precisely positioned through the second positioning structures 110d, 110f by adjusting a size of the second positioning structures 110d, 110f in the manufacturing process of the frame 110, so that the lens assemblies 120a, 120b will not be poorly positioned because an overall size of the second inner surfaces 110c, 110e of the frame 110 cannot be precisely controlled.

In the embodiment shown in FIG. 5, the two second inner surfaces 110c are vertical to each other, and the two second inner surfaces 110e are vertical to each other. Each of the second positioning structures 110d includes two second protrusion bars R2, and each of the side surfaces S2 of the lens assembly 120a leans against the corresponding two second protrusion bars R2. Each of the second positioning structures 110f includes two second protrusion bars R3, and each of the side surfaces S3 of the lens assembly 120b leans against the corresponding two second protrusion bars R3. In other embodiments, the second positioning structure 110d may be a structure in another form formed on the second inner surface 110c, the second positioning structure 110f may be a structure in another form formed on the second inner surface 110e, and the invention is not limited hereto.

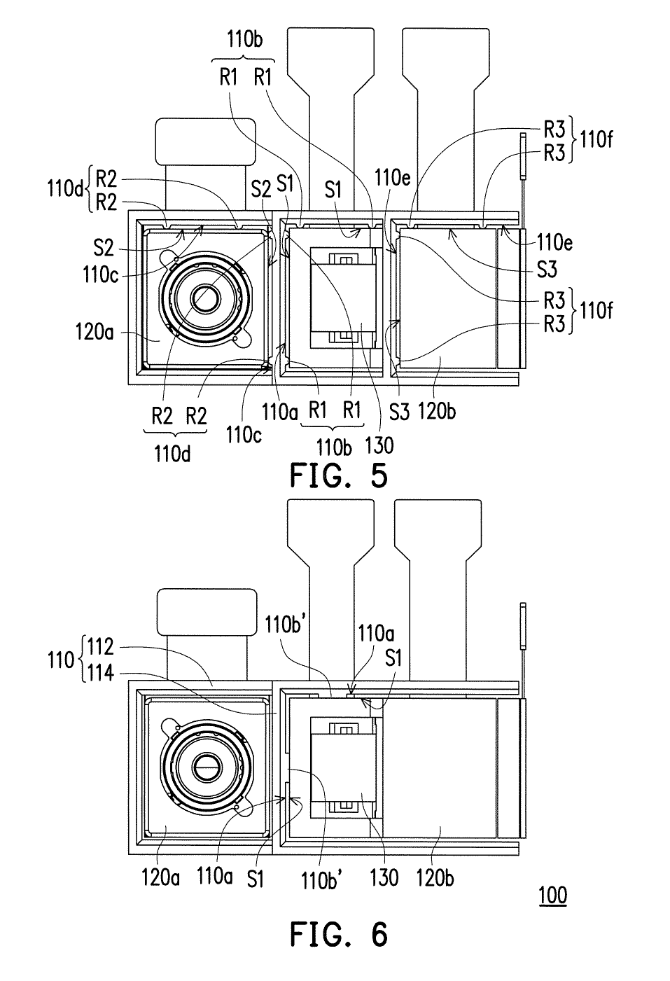

FIG. 6 is a top view illustrating a lens module according to another embodiment of the invention. The embodiment shown in FIG. 6 differs from the embodiment shown in FIG. 2 in that each of first positioning structures 110b′ is not two ribs, and each of the first positioning structures 110b′ is a single protrusion portion having a greater contact area. In other embodiments, this protrusion portion having a greater contact area may also be used to position the lens assemblies 120a, 120b, and the invention is not limited hereto.

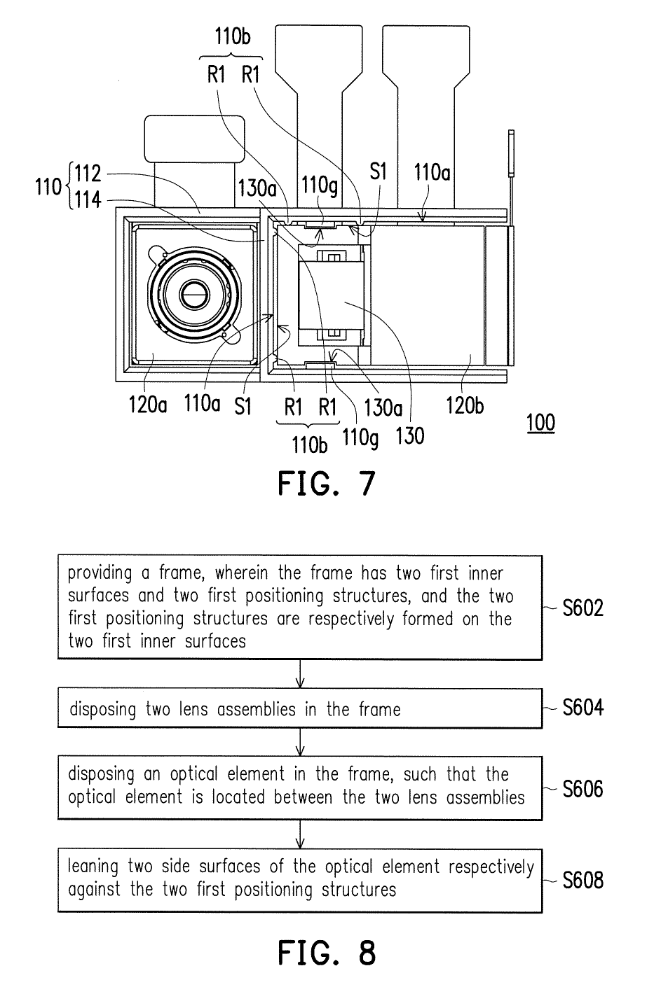

FIG. 7 is a top view illustrating a lens module according to another embodiment of the invention. The embodiment shown in FIG. 7 differs from the embodiment shown in FIG. 2 in that an inner side of the frame 110 includes two protrusion ribs 110g, and an outer side of the optical element 130 has two recesses 130a. The two protrusion ribs 110g respectively fit with the two recesses 130a, such that the optical element 130 is more securely fixed in the frame 110. In other embodiments, the recesses and the protrusion ribs may also work together to fix the lens assemblies 120a, 120b, and the invention is not limited hereto.

An assembling method of the lens module of the foregoing embodiments is described below. FIG. 8 is a flowchart illustrating an assembling method of a lens module according to an embodiment of the invention. Referring to FIG. 1 and FIG. 8, first, a frame 110 is provided, wherein the frame 110 has two first inner surfaces 110a and two first positioning structures 110b, and the two first positioning structures 110b are respectively formed on the two first inner surfaces 110a (step S602). Then, two lens assemblies 120a, 120b are disposed in the frame 110 (step S604). An optical element 130 is disposed in the frame 110, such that the optical element 130 is located between the two lens assemblies 120a, 120b (step S606). Two side surfaces S1 of the optical element 130 are respectively leant against the two first positioning structures 110b (step S608).

In the assembling method above, the two lens assemblies 120a, 120b and the optical element 130 are arranged along a first direction D1. An optical axis A1 of the lens assembly 120a is configured to be perpendicular to the first direction D1 and not to pass through the optical element 130. An optical axis A2 of the lens assembly 120b is configured to be parallel to the first direction D1 and to pass through the optical element 130. In the assembling method above, each of the side surfaces S1 of the optical element 130 leans against corresponding two first protrusion bars R1. In the assembling method above, corresponding to the embodiment shown in FIG. 5, two side surfaces S2 of the lens assembly 120a are respectively leant against two second positioning structures 110d, and two side surfaces S3 of the lens assembly 120b are respectively leant against two second positioning structures 110f. Specifically, each of the side surfaces S2 of the lens assembly 120a is leant against corresponding two second protrusion bars R2, and each of the side surfaces S3 of the lens assembly 120b is leant against corresponding two second protrusion bars R3. In the assembling method above, corresponding to the embodiment shown in FIG. 7, protrusion ribs 110g of the frame 110 are fit with recesses 130a of the optical element 130.

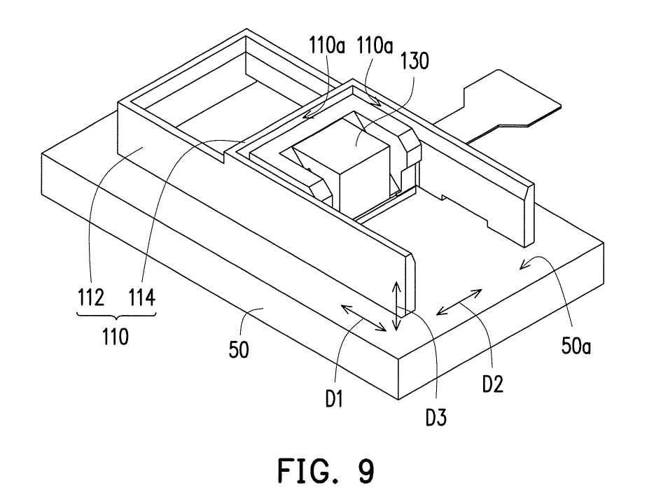

FIG. 9 illustrates a positioning method of the optical element of FIG. 1. Referring to FIG. 9, in the assembling method above, the frame 110 is placed on a positioning plane 50a of a jig 50, the optical element 130 is pushed along the first direction D1 to one of the first positioning structures 110b (illustrated in FIG. 2 and FIG. 3), the optical element 130 is pushed along the second direction D2 to the other one of the first positioning structures 110b (illustrated in FIG. 2 and FIG. 3), and the optical element 130 is pushed along the third direction D3 to the positioning plane 50a, such that the optical element 130 is positioned in all directions. The first direction D1, the second direction D2, and the third direction D3 are perpendicular to each other. Similarly, the lens assemblies 120a, 120b are positioned by using the jig 50, as described below.

In the assembling method above, corresponding to the embodiment shown in FIG. 5, the frame 110 is placed on the positioning plane 50a of the jig 50, the lens assembly 120a and the lens assembly 120b are respectively pushed along the first direction D1 to one of the second positioning structures 110d and one of the second positioning structures 110f, the lens assembly 120a and the lens assembly 120b are respectively pushed along the second direction D2 to the other one of the second positioning structures 110d and the other one of the second positioning structures 110f, and the lens assembly 120a and the lens assembly 120b are pushed along the third direction D3 to the positioning plane 50a, such that the lens assemblies 120a, 120b are positioned in all directions.

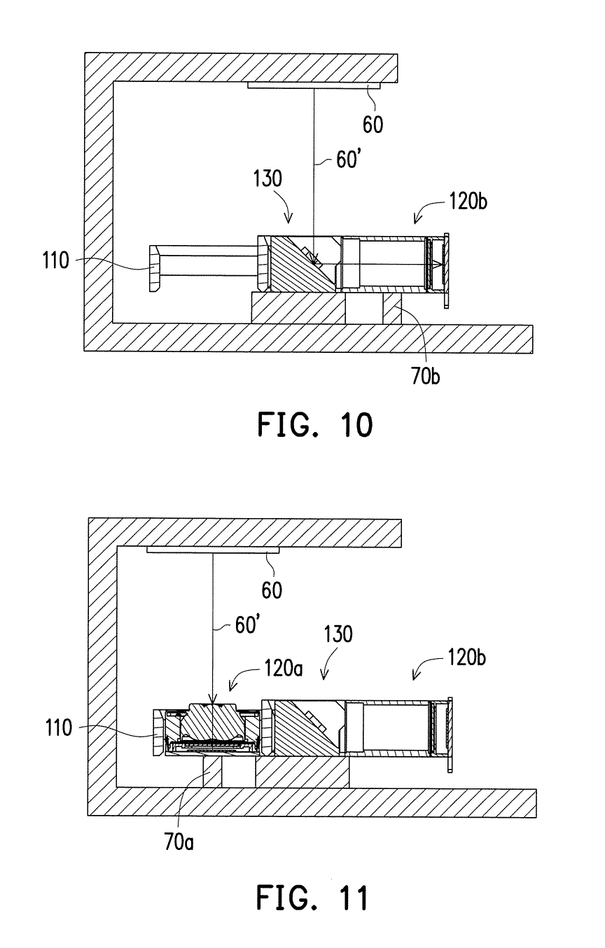

After positioning of the optical element 130 is completed by using the jig 50 and the first positioning structures 110b of the frame 110 as described above, the lens assembly 120a and the lens assembly 120b may be further positioned by optical calibration as described below. FIG. 10 and FIG. 11 illustrate a positioning method of the lens assemblies of FIG. 1. Referring to FIG. 10, in the assembling method above, the optical element 130 is aligned with a calibration pattern 60, and an image light beam 60′ of the calibration pattern 60 is transmitted to the lens assembly 120b through the optical element 130 to allow the lens assembly 120b to capture a calibration image corresponding to the calibration pattern 60 and to adjust a tilted angle of the lens assembly 120b relative to the frame 110 according to the calibration image to precisely position the lens assembly 120b. Moreover, referring to FIG. 11, in the assembling method above, the lens assembly 120a is aligned with the calibration pattern 60, and by capturing a calibration image corresponding to the calibration pattern 60 through the lens assembly 120a and adjusting a tilted angle of the lens assembly 120a relative to the frame 110 according to the calibration image, the lens assembly 120a is precisely position. For example, the calibration pattern 60 includes a square pattern. If the pattern in the calibration image is also a square, it is determined that the adjusted angle meets the expectation. In other embodiments, optical calibration may be performed through other types of calibration patterns and methods, and the invention is not limited hereto. Moreover, in the adjustment process above, adjustment axes 70a, 70b having a six-axis adjustment function, for example, are used to respectively adjust angles of the lens assembly 120a and the lens assembly 120b.

It is noted that if the embodiment shown in FIG. 1 is implemented with the embodiment shown in FIG. 10 and FIG. 11, the lens assembly 120a and the lens assembly 120b are positioned by optical calibration only. However, the invention is not limited hereto. If the embodiment shown in FIG. 5 is implemented with the embodiment shown in FIG. 10 and FIG. 11, the lens assembly 120a and the lens assembly 120b may also be positioned through the second positioning structures 110d, 110f of the frame 110, in addition to being positioned by optical calibration.

After positioning of the lens assembly 120a, the lens assembly 120b, and the optical element 130 is completed by the method described in the embodiments above, a gel is filled between the frame 110 and the lens assemblies 120a, 120b, and the gel is filled between the frame 110 and the optical element 130 to fix the lens assemblies 120a, 120b and the optical element 130.

In summary of the above, in the embodiments of the invention, the optical element is disposed between the two lens assemblies. The optical element is, for example, a prism, a reflecting mirror, or another element that changes a transmission direction of a light beam, such that an image light beam from outside is changed in its transmission direction and then is transmitted to the telephoto lens assembly, and thereby there is greater design freedom for a configuration direction of the telephoto lens assembly in the lens module. Accordingly, when the lens module of the embodiments of the invention is applied to a portable electronic device, a size and a corresponding telephoto capability of the telephoto lens assembly are not strictly confined by the miniaturization design trend of portable electronic devices. Moreover, the two first inner surfaces of the frame are respectively provided with the first positioning structures. Accordingly, the optical element is precisely positioned through the first positioning structures by adjusting the size of the first positioning structures in the manufacturing process of the frame, so that the optical element will not be poorly positioned because the overall size of the first inner surfaces of the frame cannot be precisely controlled. In addition, the lens assemblies are positioned through the second positioning structures of the frame, and/or the lens assemblies are positioned by optical calibration, so that the lens assemblies also exhibit excellent positioning precision.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A lens module comprising:
a frame having two first inner surfaces and two first positioning structures, wherein the two first positioning structures are respectively formed on the two first inner surfaces;
two lens assemblies disposed in the frame; and
an optical element disposed in the frame and located between the two lens assemblies, wherein two side surfaces of the optical element respectively lean against the two first positioning structures.

2. The lens module according to claim 1, wherein an optical axis of one of the lens assemblies passes through the optical element, and an optical axis of the other one of the lens assemblies does not pass through the optical element.

3. The lens module according to claim 1, wherein the frame comprises a frame portion and a partition portion, wherein the frame portion surrounds the two lens assemblies and the optical element, the partition portion is located in the frame portion, the optical element and one of the lens assemblies are respectively located on two opposite sides of the partition portion, the frame portion has one of the first inner surfaces, and the partition portion has the other one of the first inner surfaces.

4. The lens module according to claim 1, wherein the two first inner surfaces are vertical to each other.

5. The lens module according to claim 1, wherein each of the first positioning structures comprises two first protrusion bars, and each of the side surfaces of the optical element leans against the corresponding two first protrusion bars.

6. The lens module according to claim 1, wherein the frame has two second inner surfaces and two second positioning structures, wherein the two second positioning structures are respectively formed on the two second inner surfaces, and two side surfaces of one of the lens assemblies respectively lean against the two second positioning structures.

7. The lens module according to claim 6, wherein the two second inner surfaces are vertical to each other.

8. The lens module according to claim 6, wherein each of the second positioning structures comprises two second protrusion bars, and each of the side surfaces of the lens assembly leans against the corresponding two second protrusion bars.

9. The lens module according to claim 1, wherein an inner side of the frame comprises a protrusion rib, and an outer side of the optical element has a recess, wherein the protrusion rib fits with the recess.

10. An assembling method of a lens module, comprising:
providing a frame having two first ironer surfaces and two first positioning structures, wherein the two first positioning structures are respectively formed on the two first inner surfaces;
disposing two lens assemblies respectively in the frame;
disposing an optical element in the frame, such that the optical element is located between the two lens assemblies; and
leaning two side surfaces of the optical element respectively against the two first positioning structures.

11. The assembling method of a lens module according to claim 10, wherein the step of disposing the two lens assemblies in the frame comprises:
configuring an optical axis of one of the lens assemblies to pass through the optical element; and
configuring an optical axis of the other one of the lens assemblies not to pass through the optical element.

12. The assembling method of a lens module according to claim 10, wherein the step of disposing the two lens assemblies and the optical element in the frame comprises:
arranging the two lens assemblies and the optical element along a first direction;
configuring an optical axis of one of the lens assemblies to be perpendicular to the first direction; and
configuring an optical axis of the other one of the lens assemblies to be parallel to the first direction.

13. The assembling method of a lens module according to claim 10, comprising:
placing the frame on a positioning plane of a jig;
pushing the optical element along a first direction to one of the first positioning structures;
pushing the optical element along a second direction to the other one of the first positioning structures; and
pushing the optical element along a third direction to the positioning plane, wherein the first direction, the second direction, and the third direction are perpendicular to each other.

14. The assembling method of a lens module according to claim 10, wherein each of the first positioning structures comprises two first protrusion bars, and the step of leaning the two side surfaces of the optical element respectively against the two first positioning structures comprises:
leaning each of the side surfaces of the optical element against the corresponding two first protrusion bars.

15. The assembling method of a lens module according to claim 10, wherein the frame has two second inner surfaces and two second positioning structures, and the two second positioning structures are respectively formed on the two second inner surfaces, the assembling method comprising:
leaning two side surfaces of one of the lens assemblies respectively against the two second positioning structures.

16. The assembling method of a lens module according to claim 15, comprising:
placing the frame on a positioning plane of a jig;
pushing the lens assembly along a first direction to one of the second positioning structures;
pushing the lens assembly along a second direction to the other one of the second positioning structures; and
pushing each of the lens assemblies along a third direction to the positioning plane, wherein the first direction, the second direction, and the third direction are perpendicular to each other.

17. The assembling method of a lens module according to claim 15, wherein each of the second positioning structures comprises two second protrusion bars, and the step of leaning the two side surfaces of the lens assembly respectively against the two second positioning structures comprises:
leaning each of the side surfaces of the lens assembly against the corresponding two second protrusion bars.

18. The assembling method of a lens module according to claim 10, wherein an inner side of the frame comprises a protrusion rib, and an outer side of the optical element has a recess, the assembling method comprising:
fitting the protrusion rib with the recess.

19. The assembling method of a lens module according to claim 10, comprising:
aligning the optical element with a calibration pattern;
transmitting an image light beam of the calibration pattern to one of the lens assemblies through the optical element to allow the lens assembly to capture a calibration image corresponding to the calibration pattern; and
adjusting a tilted angle of the lens assembly relative to the frame according to the calibration image.

20. The assembling method of a lens module according to claim 10, comprising:
aligning one of the lens assemblies with a calibration pattern;
capturing a calibration image corresponding to the calibration pattern through the lens assembly; and
adjusting a tilted angle of the lens assembly relative to the frame according to the calibration image.
